(19) United States
(12) Patent Application Publication
(10) Pub. No.: US 2014/0211618 A1
(43) Pub. Date: Jul. 31, 2014

(54) ACCESS POINT AND METHOD OF CONTROLLING WIRELESS COMMUNICATIONS

(71) Applicant: Furuno Electric Co., Ltd., Nishinomiya (JP)

(72) Inventor: Shigeru Karaki, Nishinomiya (JP)

(73) Assignee: Furuno Electric Co., Ltd., Nishinomiya (JP)

(21) Appl. No.: 14/156,377

(22) Filed: Jan. 15, 2014

(30) Foreign Application Priority Data
Jan. 30, 2013 (JP) 2013-015942

(51) Int. Cl. H04W 36/00; H04W 28/02

(52) U.S. Cl. CPC H04W 36/0016; H04W 28/0289
USPC 370/230; 370/331

(57) ABSTRACT

An access point of wireless communications is provided. The access point includes a wireless communication unit for wirelessly communicating with a plurality of wireless communication terminals, a communicating state managing unit for managing information on a communicating state between the wireless communication unit and each of the wireless communication terminal, and a disconnecting unit for cutting a connection between the wireless communication unit and the wireless communication terminal of which the communicating state managed by the communicating state managing unit gets worse than a predetermined condition.

### CROSS-REFERENCE TO RELATED APPLICATION(S)

The application claims priority under 35 U.S.C. §119 to Japanese Patent Application No. 2013-015942, which was filed on Jan. 30, 2013, the entire disclosure of which is hereby incorporated by reference.

### TECHNICAL FIELD /

The present invention relates to a configuration for stimulating roaming of a wireless communication terminal in a situation where a plurality of access points are installed.

### BACKGROUND OF THE INVENTION

In recent years, for example, on the campuses of universities and colleges, and in the train station yards, access points are installed to provide wireless networks (for example, wireless LANs) to a large number of anonymous users. Each access point is configured to wirelessly communicate with wireless communication terminals which are carried around by the users. Each wireless communication terminal is connectable with the network via one access point when the terminal is located within a service area of the access point. Thus, the users can use the wireless network, while moving freely within the service area.

Since the reach of the service area of each access point is limited, a plurality of access points are typically installed to provide a wireless network in a broad area. As one wireless communication terminal moves from a service area of a certain access point to another service area of another access point, the connecting access point is automatically switched from one to another. Such a function to automatically switch the access point is called “roaming.” Note that, in order to allow a seamless switching of the access point, one service area is partially overlapped with another service area.

Within such an overlapped area, the wireless communication terminal can selectively connect with one of a plurality of access points. Thus, the wireless communication terminal can maintain a good communicating state at all time by roaming to an access point with a good communication at a suitable timing. However, some of the common wireless communication terminals do not switch to another access point unless the connections with the current access points are disconnected beforehand. For this reason, even if there are other access points with better communicating states, the wireless communication terminal may continue the communication with the same access point with a bad communicating state for a long period of time. That is, roaming may not be performed at an ideal timing.

Further, in this kind of wireless network, when accesses from many communication terminals concentrate on one access point, drawbacks such as lowering of signaling speeds may be caused. Still further, since there is a typical limit in the number of communication terminals which can simultaneously access one access point, some kind of measures are needed in such an environment where many users use one access point simultaneously (e.g., classrooms of a university or college, or platforms of a train station). Therefore, in terms of a load distribution, major parts of the service areas of the plurality of access points may be overlapped. In such a case, since a wireless communication terminal within a service area can select one from the plurality of access points, a distributing effect of the accesses over the plurality of access points can be expected.

However, even if the plurality of access points are installed, accesses may still concentrate on a particular access point in some cases. For example, in a classroom of a university or college, when students using wireless communication terminals sit around one particular location, accesses therefrom concentrate only on an access point near the location, while other access points in the same classroom will not be used, which is inefficient. Therefore, for the many-user situation, it is insufficient to just install the plurality of access points and, thus, certain alternatives to stimulate the roaming so that accesses are distributed over the plurality of access points.

JP2007-110543A discloses a configuration in which, when performing wireless communications at a place where one of a plurality of access points is selectively connected, the connecting access point is switched at the wireless communication terminal (wireless communication device) side depending on the access concentrations. According to this configuration, since the wireless communication terminal switches to another access point when accesses are concentrated on a certain access point, roaming can be performed at a suitable timing. In addition, in terms of the network as a whole, the access concentration on a particular access point is reduced and, therefore, it can be said that there is an effect for distributing accesses over the plurality of access points.

In the meantime, JP2000-156689A discloses a configuration in which, when an access point becomes impossible to connect with a wired LAN due to some kinds of failures, the access point disconnects a wireless communication terminal which is connected wirelessly thereto. JP2006-352660A discloses a configuration in which a communicating state is determined by transceiving a predetermined signal between an access point and a wireless communication terminal.

However, in a wireless network used by a large number of anonymous users, it cannot be assumed that all the wireless communication terminals have such a function as disclosed in JP2007-110543A. If there are many wireless communication terminals which do not have the function disclosed in JP2007-110543A in the network, the access distributing effect can hardly be expected. In addition, since the configuration disclosed in JP2007-110543A switches the access point at the wireless communication terminal side, the access point side cannot control the switching.

As described above, it cannot be said that the configuration disclosed in J2007-110543A is an optimal configuration for distributing the communication load over a plurality of access points.

### SUMMARY OF THE INVENTION

The present invention is made in view of the above situations, and it provides a system in which a wireless communication terminal can connect with an access point having a better radio wave environment in a situation where a plurality of access points are installed, and roaming is easily controllable at the access point side.

According to one aspect of the present invention, an access point of wireless communications is provided. The access point includes a wireless communication unit for wirelessly communicating with a plurality of wireless communication terminals, a communicating state managing unit for managing information on a communicating state between the wireless communication unit and each of the wireless communication terminal, and a disconnecting unit for cutting a connection between the wireless communication unit and the wireless communication terminal of which the communicating state managed by the communicating state managing unit gets worse than a predetermined condition.

Thus, since the wireless communication terminal of which the communicating state is bad is disconnected at the access point side, the wireless communication terminal can be urged roaming to connect with another access point of which the communicating state is better. Therefore, since accesses are distributed over the plurality of access points and a possibility for each wireless communication terminal to connect with a more advantageous access point is increased, performances as the entire wireless network can be improved.

The communicating state managing unit may update the information on the communicating state periodically or irregularly for each of the wireless communication terminals.

That is, since the communicating state between the access point and the wireless communication terminal changes every moment, the information on the communicating state is updated periodically (or irregularly) so that the latest information is always stored. Thus, the disconnecting unit can determine the communicating state of each wireless communication terminal based on the latest information.

The communicating state managing unit may transmit a predetermined signal to the wireless communication terminal that has not communicated with the access point for a predetermined period of time, and may update the information on the communicating state based on a communicating state of a response signal for the predetermined signal from the wireless communication terminal.

Thus, a signal is positively transmitted from the access point side to the wireless communication terminal that has not communicated with the access point to urge a response from the wireless communication terminal, and the latest communicating state of the wireless communication terminal can be acquired.

The information on the communicating state may be an intensity of a radio wave received from the wireless communication terminal by the wireless communication unit.

Thus, the intensity of the radio wave received from the wireless communication terminal can be utilized as an index of the communicating state of the wireless communication terminal.

The information on the communicating state may be a modulation rate of a communication packet exchanged between the wireless communication unit and the wireless communication terminal.

Thus, the modulation rate of the communication packet between the access point and the wireless communication terminal can be utilized as an index of the communicating state of the wireless communication terminal.

The information on the communicating state may be the number of retries of the communication between the wireless communication unit and the wireless communication terminal.

Thus, the number of retries of the communication between the wireless communication unit and the wireless communication terminal can be utilized as an index of the communicating state of the wireless communication terminal.

The information on the communicating state may be an error rate of the communication between the wireless communication unit and the wireless communication terminal.

Thus, the error rate of the communication between the wireless communication unit and the wireless communication terminal can be utilized as an index of the communicating state of the wireless communication terminal.

The disconnecting unit may cut the connection between the wireless communication unit and the wireless communication terminal of which the communicating state gets worse than the predetermined condition based on the information on the communicating state acquired from multiple communications between the wireless communication unit and the wireless communication terminal.

That is, although errors are typically contained in the information which can be acquired from one-time communication, the communicating state of the wireless communication terminal can be determined more accuracy by taking the information acquired from the multiple communications into consideration.

When the wireless communication terminal that is disconnected reconnects with the wireless communication unit, the disconnecting unit may not cut the connection between the wireless communication terminal and the wireless communication unit for a predetermined period of time.

Thus, frequent repetition of disconnection and reconnection between the wireless communication terminal and the wireless communication unit can be reduced.

The disconnecting unit may adjust the predetermined condition based on information on congesting states of one or more other access points.

Thus, an adaptive control is possible for the plurality of access points according to the congestion situation(s).

The information on the congesting state of the access point may include at least one of the number of the wireless communication terminals that are connecting with the access point and traffic of the access point per unit time.

Thus, the information, such as the number of the wireless communication terminals connected with the access point, and/or the traffic of the access point per unit time, can be utilized as an index of the congesting state of the access point.

The access point may transmit the information on the congesting state of the access point to another access point, while the access point may receive the information on the congesting state of the another access point. The access point may detect a relative congesting state of the access point based on the information on the congesting state of the access point and the received congesting state of the another access point, and may adjust the predetermined condition according to the relative congesting state.

Thus, each access point can also acquire the congesting states of other access points by exchanging the information on the congesting states with the other access points. Therefore, the access point can appropriately adjust the predetermined condition of the access point after determining the relative congesting state thereof

The disconnecting unit may loosen up the predetermined condition as the access point becomes relatively congested compared with another access point.

Thus, the connection between the access point and the wireless communication terminal becomes easier to be cut as the congestion of the access point increases. As a result, since each wireless communication terminal can be moved from the congested access point to the non-congested access point, a plurality of wireless communication terminals can be distributed and equalized over the plurality of access points.

According to another aspect of the present invention, a method of controlling wireless communications is provided. The method includes wirelessly communicating between an access point and a plurality of wireless communication terminals, managing, by the access point, information on a communicating state between the access point and the wireless communication terminal for each wireless communication terminal, and cutting, by the access point, a connection between the access point and the wireless communication terminal of which the communicating state gets worse than a predetermined condition.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a block diagram illustrating an overall configuration of a wireless network of one embodiment;

FIG. 2 is a block diagram of a first access point;

FIG. 3 is a table illustrating data of a communicating state table;

FIG. 4 is a view illustrating a situation where the wireless communication terminal established a connection with the first access point;

FIG. 5 is a view illustrating a situation where the number of the wireless communication terminals which is accessing the first access point is increased;

FIG. 6 is a view illustrating a situation where the connection between the first access point and the wireless communication terminal is disconnected;

FIG. 7 is a view illustrating a situation where the wireless communication terminal resumed a communication with a second access point;

FIG. 8 is a view illustrating a situation where the wireless communication terminal is moving;

FIG. 9 is a view illustrating a situation where the connection between the wireless communication terminal and the first access point is disconnected; and

FIG. 10 is a view illustrating a configuration of another wireless network according to a modification to the embodiment.

### DETAILED DESCRIPTION

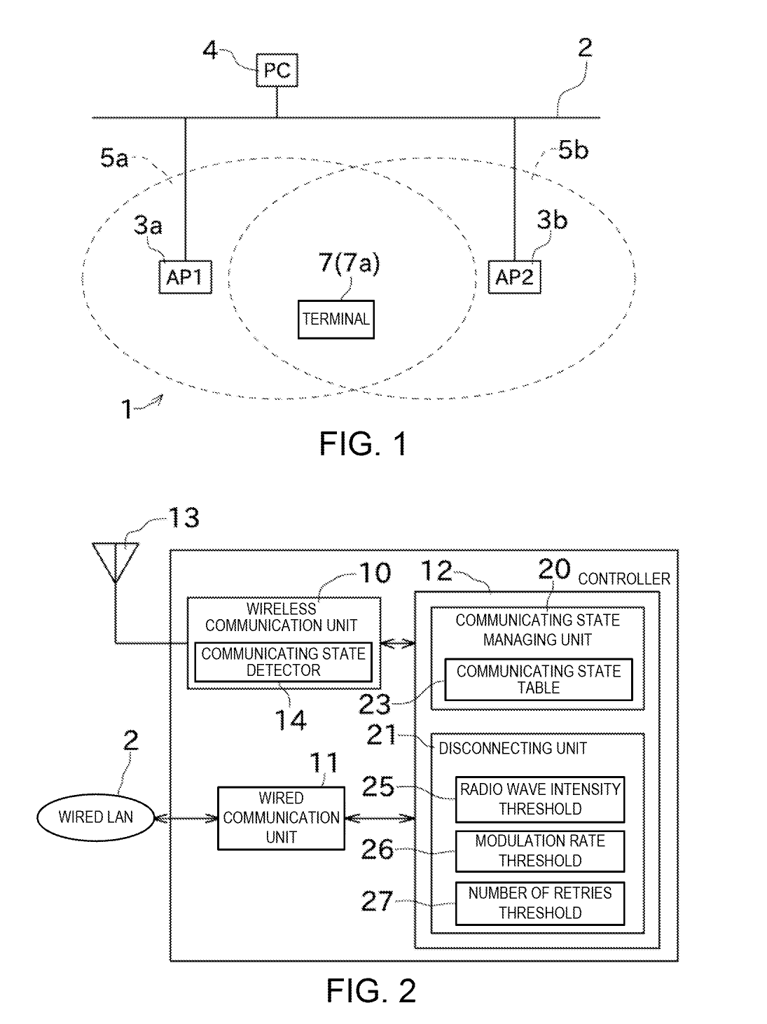

Below, one embodiment of the present invention is described with reference to the accompanying drawings. FIG. 1 illustrates a schematic block diagram of a wireless network comprised of access points according to the embodiment of the invention.

A wireless network 1 is configured, for example, as wireless LANs (Local Area Networks) based on the known wireless standards of IEEE 802.11. The wireless network 1 includes a wired network 2 (e.g., a wired LAN) which is a backbone of the network, and a plurality of access points connected with the wired network 2 (in this embodiment, a first access point 3a and a second access point 3b). Although only two access points 3a and 3b are illustrated in FIG. 1, three or more access points may also be provided. Note that the plurality of access points 3a and 3b which constitute the wireless network 1 have fundamentally the same configuration. Therefore, hereinafter, the first access point 3a may only be described representing the access points and, thus, description of other access points may be omitted. In addition, although three or more access points may be provided, only two access points 3a and 3b may be described in the following description.

The first access point 3a can communicate, via the wired network 2, with other devices (in FIG. 1, the second access point 3b and a personal computer (PC) 4). The first access point 3a is also configured to wirelessly communicate based on the above-described wireless standards.

Here, a reachable range of a radio wave from an access point with a radio wave intensity necessary for the communication is referred to as “the service area,” which may also be referred to as a “coverage” of the access point. In FIG. 1, the service areas of the access points 3a and 3b are schematically indicated by dotted lines, where a symbol “5a” denotes the service area of the first access point 3a, and a symbol “5b” denotes the service area of the second access point 3b. In this embodiment, the service areas 5a and 5b of the access points 3a and 3b which constitute the wireless network 1 are arranged to mutually overlap at least in parts thereof.

Each wireless communication terminal 7 which uses the wireless network 1 is configured to wirelessly communicatable with any one of the access points based on the above-described wireless standards. The wireless communication terminal 7 establishes a connection by wireless communications with the access point to connect to other wireless communication terminals 7 connected with the wireless network 1, or to other devices connected with the wired network 2 (in FIG. 1, the personal computer 4), via the access point concerned. The wired network 2 may be connected with a WAN (Wide Area Network), such as the Internet. In such a case, the wireless communication terminal 7 can use the WAN via the access point.

Next, a configuration of the access point of this embodiment is described in detail. The configuration of the first access point 3a is illustrated in FIG. 2. Note that, as described above, other access points which constitute the wireless network 1 (in FIG. 1, the second access point 3b) have the same configuration.

The first access point 3a mainly includes a wireless communication unit 10, a wired communication unit 11, and a controller 12.

The wireless communication unit 10 includes an antenna 13 for wireless communications, and it is configured to wirelessly communicate with the wireless communication terminal(s) 7 by establishing a wireless connection therebetween. Note that the wireless communication unit 10 can establish connections with a plurality of wireless communication terminals 7.

The wireless communication unit 10 has a function as a communicating state detector 14. The communicating state detector 14 is configured so that, when the wireless communication unit 10 wirelessly communicates with the wireless communication terminal 7, detects information on a communicating state between in the wireless communication unit 10 and the wireless communication terminal 7 (hereinafter, simply referred to as “the communicating state of the wireless communication terminal 7”).

The communicating state detector 14 detects an intensity of a radio wave from the wireless communication terminal 7 which is received by the wireless communication unit 10 as information on the communicating state of the wireless communication terminal 7. It can be determined that the communicating state between the wireless communication unit 10 and the wireless communication terminal 7 is better as the radio wave intensity increases. Thus, the intensity of the radio wave from the wireless communication terminal 7 which is received by the wireless communication unit 10 (hereinafter, simply referred to as “the radio wave intensity of the wireless communication terminal 7”) can be used as one of information indicative of the communicating state between the wireless communication unit 10 and the wireless communication terminal 7.

Further, the communicating state detector 14 detects a modulation rate of a communication packet from the wireless communication terminal 7 which is received by the wireless communication unit 10 as the information on the communicating state of the wireless communication terminal 7. A communication speed is faster between the first access point 3a and the wireless communication terminal 7, as the modulation rate 32 increases. Note that the modulation rate detected by the communicating state detector 14 is not a theoretical value but an actually-measured value of the communication. For example, when the radio wave condition between the wireless communication unit 10 and the wireless communication terminal 7 is bad (e.g., when the wireless communication terminal 7 is in the distance), the communication between the wireless communication unit 10 and the wireless communication terminal 7 must be performed at a low modulation rate. Therefore, when the communication can be performed at a sufficiently high modulation rate, it can be determined that the communicating state between the wireless communication unit 10 and the wireless communication terminal 7 is good. Thus, the modulation rate of the communication packet from the wireless communication terminal 7 which is received by the wireless communication unit 10 (hereinafter, simply referred to as “the modulation rate of the wireless communication terminal”) can be used as one of the information indicative of the communicating state between the wireless communication unit 10 and the wireless communication terminal 7.

The communicating state detector 14 detects the number of retries at the time of exchanging the communication packet between the wireless communication unit 10 and the wireless communication terminal 7 as the information on the communicating state of the wireless communication terminal 7. That is, if the radio wave condition between the wireless communication unit 10 and the wireless communication terminal 7 is degraded, communication errors will frequently occur in the communications between the wireless communication unit 10 and the wireless communication terminal 7 to increase the number of retries of the packet transmission. Therefore, it can be determined that the communicating state between the wireless communication unit 10 and the wireless communication terminal 7 is better as the number of retries becomes less. Thus, the number of retries at the time of exchanging the communication packet between the wireless communication unit 10 and the wireless communication terminal 7 (hereinafter, simply referred to as “the number of retries of the wireless communication terminal”) can be used as one of the information indicative of the communicating state between the wireless communication unit 10 and the wireless communication terminal 7.

Note that since there may be a plurality of wireless communication terminals 7 connected to the wireless network 1, the communicating states of the wireless communication terminals 7 may differ from each other. For this reason, when the wireless communication unit 10 wirelessly communicates with one or more of the plurality of wireless communication terminals 7, the communicating state detector 14 detects the information on the communicating states (in this embodiment, the radio wave intensity, the modulation rate, and the number of retries) for each of the wireless communication terminals 7.

The wired communication unit 11 can communicate, via the wired network 2, to other devices (in FIG. 2, the second access point 3b and the personal computer 4) connected with the wired network 2.

The controller 12 includes an arithmetic element such as a microprocessor, and it can control the communications of both the wireless communication unit 10 and the wired communication unit 11. In addition, the controller 12 has a function as a communicating state managing unit 20 and a disconnecting unit 21.

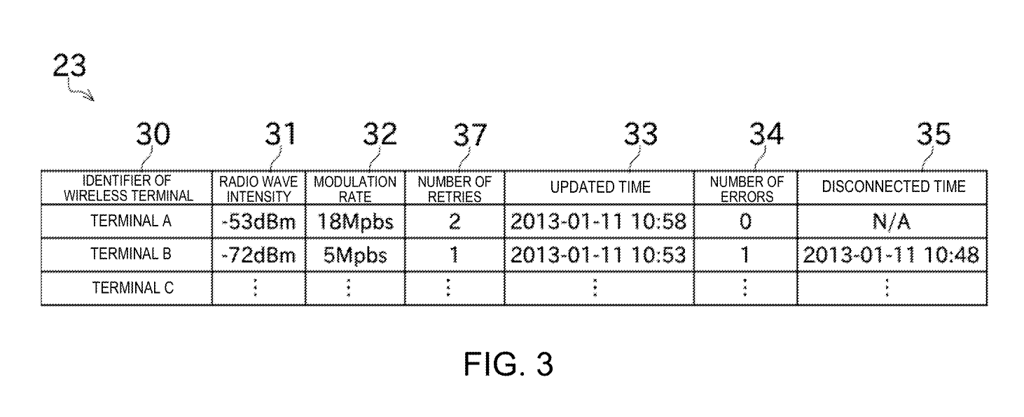

The communicating state managing unit 20 records and manages the information on the communicating state of each wireless communication terminal 7 which is detected by the communicating state detector 14. The communicating state managing unit 20 manages the information on the communicating states of the wireless communication terminals 7 in the form of a table illustrated in FIG. 3. FIG. 3 illustrates example data of the table (hereinafter, referred to as “the communicating state table 23”) managed by the communicating state managing unit 20. Note that the communicating state table 23 merely illustrates data managed by the communicating state managing unit 20, which are indicated in the form of a table in terms of facilitating the understandings of the data and, thus, the data are not limited to the example data and do not represent actually-managed data of the communicating state managing unit 20.

As illustrated in FIG. 3, the communicating state table 23 records information, for each wireless communication terminal 7, including an identifier 30 of the wireless communication terminal, a radio wave intensity 31 of the wireless communication terminal, the modulation rate 32 of the wireless communication terminal, the number of retries 37 of the wireless communication terminal, and an updated time 33 of the information on the communicating state of the wireless communication terminal, and the number of errors 34 of the wireless communication terminal.

The identifier 30 is information to identify the wireless communication terminal 7, and, for example, information including a name and a MAC address of each wireless communication terminal 7 is recorded as the identifier 30. The information on the communicating state (the radio wave intensity 31, the modulation rate 32, and the number of retries 37) and other information of each wireless communication terminal 7 recorded so as to be associated with the respective identifiers 30. In such a case, the communicating state managing unit 20 can manage the information on the communicating states and other information of the wireless communication terminals 7 for each wireless communication terminal 7.

As for the value of the information on the communicating state of each wireless communication terminal 7 which is managed with the communicating state table 23, the value detected by the communicating state detector 14 is recorded. Here, the value detected by the communicating state detector 14 does not need to be recorded as it is, and, for example, a certain value calculated based on the value detected by the communicating state detector 14 may be recorded in the communicating state table 23. Each time the communicating state detector 14 newly detects the information on the communicating state (the radio wave intensity, the modulation rate, and the number of retries) of a certain wireless communication terminal 7, the communicating state managing unit 20 updates the data recorded in the communicating state table 23 with the detected information on the wireless communication terminal 7 (the radio wave intensity 31, the modulation rate 32, and the number of retries 37). The communicating state managing unit 20 also records, as an updated time 33, a time stamp of the time at which the new value was acquired. In such a case, the information on the communicating state of the wireless communication terminal recorded in the communicating state table 23 can be updated for each wireless communication terminal 7.

Note that the communicating state detector 14 cannot acquire the information on the communicating state of the wireless communication terminal 7, unless it has communicated with the wireless communication terminal 7. For this reason, if the communication has not been performed between the wireless communication terminal 7 and the first access point 3a for a long period of time, the values of the radio wave intensity 31, the modulation rate 32, and the number of retries 37 which are recorded in the communicating state table 23 may get old.

Thus, the communicating state managing unit 20 refers to the updated time 33 recorded in the communicating state table 23 to detect a wireless communication terminal 7 of which the information on the communicating state (the radio wave intensity 31, the modulation rate 32, and the number of retries 37) has not been updated for a predetermined update interval. The communicating state managing unit 20 transmits to the detected wireless communication terminal 7 a predetermined request signal to which the wireless communication terminal 7 must respond (for example, a dummy packet, such as a NULL data packet). Then, the record of the communicating state table 23 is updated with the values of the radio wave intensity, the modulation rate, and the number of retries which are detected by the communicating state detector 14 when a response packet is received from the wireless communication terminal 7. Accordingly, since the information on the communicating state of each wireless communication terminal 7 can be certainly updated at every predetermined update interval, the communicating state table 23 is always maintained with the latest data.

In terms of maintaining the communicating state table 23 with the latest data, the update interval is better to be as short as possible. However, if the request signal is frequently transmitted to the wireless communication terminal 7, since the wireless communication terminal 7 must reply the response packet frequently, drawbacks such as exhaustion of a battery of the wireless communication terminal 7 may be stimulated. Therefore, in an actual operation of the wireless network 1, the update interval is set to a suitably long period of time to minimize the frequency of the transmission of the request signal to each wireless communication terminal 7 as needed. It may be preferred if the update interval can be set by an administrator of the wireless network 1. In this case, the administrator may set the update interval as needed to adjust the update frequency of the communicating state table 23.

Since the wireless network 1 is designed to be used by a large number of anonymous users, the wireless communication terminal 7, which exists within the service area 5a of the first access point 3a, may be changed to another terminal within the same service area. For this reason, when a connection by wireless communications is established between a wireless communication terminal 7 which is not yet recorded in the communicating state table 23 (a new wireless communication terminal), and the wireless communication unit 10, the communicating state managing unit 20 adds the identifier 30, the information on the communicating state (the radio wave intensity 31, the modulation rate 32, and the number of retries 35), and other information of the new wireless communication terminal to the communicating state table 23.

If it is in a case where, although the request signal and other signals have been transmitted to the wireless communication terminal 7, and the required response packet cannot be received from the wireless communication terminal 7, the wireless communication terminal 7 may have already been moved out of the service area 5a of the first access point 3a. The information on such a wireless communication terminal 7 may be deleted from the communicating state table 23. Thus, the communicating state managing unit 20 one records the information in the communicating state table 23, and when the required response is not obtained from the wireless communication terminal 7, it deletes the information on the wireless communication terminal 7 from the communicating state table 23 when a predetermined deletion condition is satisfied. Specifically, the communicating state managing unit 20 records the value of the number of errors 34 in the communicating state table 23 for each wireless communication terminal 7. If the required response packet is not obtained from the wireless communication terminal 7 although the communicating state managing unit 20 transmitted the signal, the communicating state managing unit 20 retries transmissions of the signal, and when the number of retries exceeds the predetermined number of times, it is concluded to be a “communication error” and the value of the number of errors 34 of the wireless communication terminal 7 is incremented. The communicating state managing unit 20 returns the value of the number of errors 34 of the wireless communication terminal 7 back to zero when the response packet is obtained from the wireless communication terminal 7. When the number of errors 34 of the wireless communication terminal 7 exceeds the predetermined value (when the situations where the response packet has not obtained exceed consecutively the predetermined number of times), the communicating state managing unit 20 deletes the information on the wireless communication terminal 7 from the communicating state table 23. Note that the information on “the number of errors 34” can also be considered as one of the information on the communicating state between the wireless communication unit 10 and the wireless communication terminal 7. This is because it can be concluded that the communicating state between the wireless communication unit 10 and the wireless communication terminal 7 is bad as the number of errors increases.

By the communicating state managing unit 20 configured as described above, the information on the communicating states of many anonymous wireless communication terminals 7 which exist in the service area 5a of the access point 3a can appropriately be managed using the communicating state table 23.

The disconnecting unit 21 refers to the data of the communicating state table 23 managed by the communicating state managing unit 20 to monitor the information on the communicating state of in each wireless communication terminal 7. The disconnecting unit 21 determines the information on the communicating state of each wireless communication terminal 7 as a whole to detect one or more wireless communication terminals 7 of which the communicating states are worse than the predetermined condition.

For example, the disconnecting unit 21 checks the communicating state table 23 at a certain interval to acquire the values of the radio wave intensity 31, the modulation rate 32, and the number of retries 35 of each wireless communication terminal 7. The disconnecting unit 21 compares the value of the radio wave intensity 31 of each wireless communication terminal 7 acquired from the communicating state table 23 with a predetermined threshold (radio wave intensity threshold) to detect the wireless communication terminal 7 of which the value of the radio wave intensity 31 is less than the threshold. Further, the disconnecting unit 21 compares the value of the modulation rate 32 of each wireless communication terminal 7 acquired from the communicating state table 23 with a predetermined threshold (modulation rate threshold) to detect the wireless communication terminal 7 of which the value of the modulation rate 32 is less than the threshold. The disconnecting unit 21 compares the value of the number of retries 37 of each wireless communication terminal 7 with a predetermined threshold (number-of-retries threshold) acquired from the communicating state table 23 to detect the wireless communication terminal 7 of which the value of the number of retries 37 exceeds the threshold.

If at least any one of the three conditions described above is satisfied (i.e., when the value of the radio wave intensity 31 of the wireless communication terminal 7 is less than the threshold, and/or when the value of the modulation rate 32 is less than the threshold, and/or when the value of the number of retries 37 exceeds the threshold), it can be concluded that the communicating state of the wireless communication terminal 7 gets worse than the predetermined condition. Therefore, it can be concluded that the disconnecting unit 21 detects the wireless communication terminal of which the communicating state gets worse than the predetermined condition. Note that, in this embodiment as described above, since the communicating state table 23 is always updated with the latest data, the disconnecting unit 21 can monitor the communicating state table 23 to detect the wireless terminal 7 of which the communicating state got worse than the predetermined condition without any delays.

The disconnecting unit 21 includes a radio wave intensity threshold storage 25 for storing the radio wave intensity threshold, a modulation rate threshold storage 26 for storing the modulation rate threshold, and a number-of-retries threshold storage 27 for storing the number-of-retries threshold. The values of the thresholds stored in the threshold storages 25, 26 and 27 can arbitrarily be set by the administrator of the wireless network 1.

The disconnecting unit 21 cuts the connection (disconnect) between the wireless communication terminal 7 and the wireless communication unit 10 when the wireless communication terminal of which the communicating state gets worse than the predetermined condition (in this embodiment, when the value of the radio wave intensity 31 or the value of the modulation rate 32 is less than the threshold, or when the value of the number of retries 35 exceeds the threshold) is detected.

Accordingly, the communication with the wireless communication terminal 7 of which the communicating state is bad can be cut from the first access point 3a side.

When the disconnecting unit 21 disconnects the wireless communication terminal 7, the communicating state managing unit 20 records a time stamp in the communicating state table 23 as a disconnected time 35 of the wireless communication terminal 7.

The disconnecting unit 21 refers to the disconnected time 35 of each wireless communication terminal 7 recorded in the communicating state table 23, and does not disconnect the wireless communication terminal 7 of which an elapsed time after the last disconnection is less than a predetermined time. Accordingly, when the wireless communication terminal 7 which was disconnected is again reconnected, repeating of the disconnection can be reduced.

Next, effects which can be acquired from the access points configured as described above are described in detail with reference to FIGS. 1 and 4 to 6.

First, operations of the wireless communication terminals 7, which are a typical model, are briefly described as the basis of the effects.

As described above, in this embodiment, the service areas 5a and 5b of the access points 3a and 3b are overlapped with each other. Here, assuming a case where one wireless communication terminal 7a, which is not turned on power (i.e., not wirelessly communicating with any of the access points), is brought into the overlapping area of the service areas 5a and 5b, and, in this state, the wireless communication terminal 7a is then powered up (the state of FIG. 1). In such a case, the wireless communication terminal 7a can start communicating with either one of the access points 3a and 3b. Thus, the wireless communication terminal 7 selectively connects with one of the access points 3a and 3b to start communications.

The selection of one of the plurality of access points 3a and 3b is a process at the wireless communication terminal 7a side, and, therefore, it is uncontrollable by the access points 3a and 3b. However, the common wireless communication terminal typically selects one of the access points with the best communicating state (such as the radio wave intensity and the signaling speed). A method of determining the communicating state of the access point includes, by the wireless communication terminal 7a, transceiving a predetermined beacon signal between the respective access points 3a and 3b and determining the communicating states of the respective access points 3a and 3b based on, for example, the radio wave intensity and the signaling speed of the beacon signal. The technique of determining the communicating state between the access points by the wireless communication terminal is also disclosed in JP2006-352660A and other known documents.

Note that, as for a wireless communication terminal without a function to automatically select an access point, a user of the wireless communication terminal manually selects the access point. Even in such a case, the user typically selects one of the access points with the best communicating state at that moment.

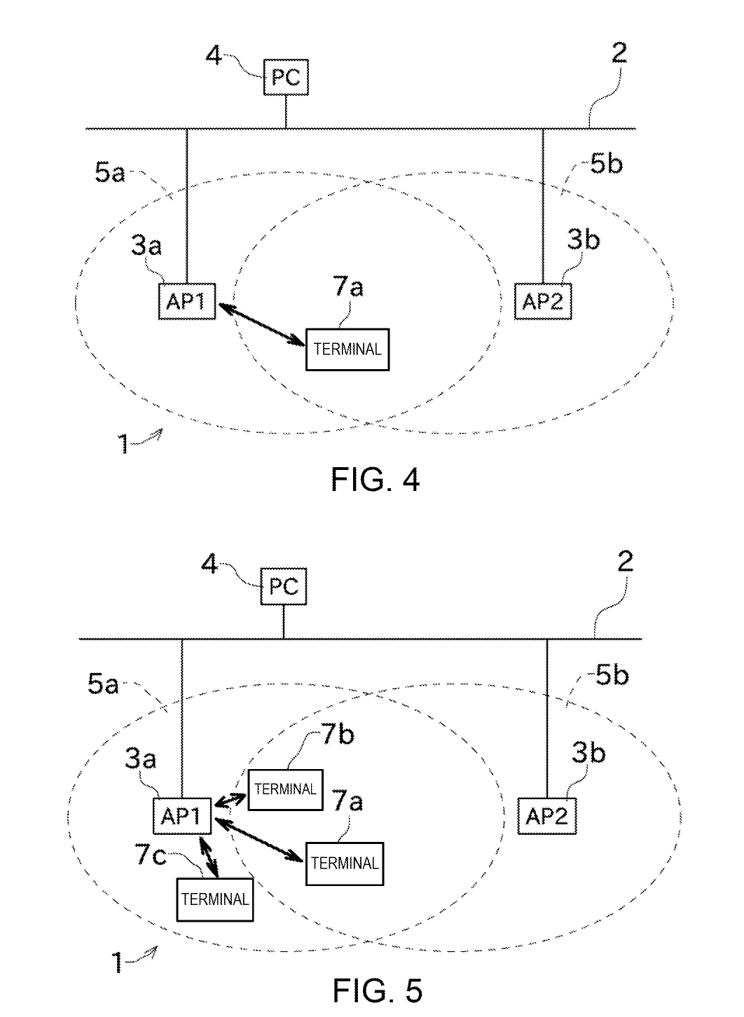

In the example of FIG. 1, the wireless communication terminal 7a is located closer toward the first access point 3a rather than the second access point 3b. For this reason, the access point with the best communicating state for the wireless communication terminal 7a of FIG. 1 is the first access point 3a. Below, it is assumed that the wireless communication terminal 7a selected the first access point 3a and started communications (the state of FIG. 4).

Then, as illustrated in FIG. 5, it is assumed that other wireless communication terminals (such as 7b and 7c) start wireless communications with the same first access point 3a. When a plurality of wireless communication terminals communicates with the same first access point 3a, congestion may occur to increase the number of retries by all the wireless communication terminals 7a, 7b and 7c (in other words, the communicating states of the wireless communication terminals are degraded).

The common wireless communication terminals typically maintain the current connections with the access point. Therefore, in the situation illustrated in FIG. 5, the wireless communication terminals 7a, 7b and 7c maintain the connections with the first access point 3a even if the communicating states are degraded (i.e., even if the number of retries increases). For this reason, if no measure is taken, the users of the wireless communication terminals 7a, 7b and 7c have to continue using the wireless network 1 in the bad communicating states and, thus, the users may feel stresses. In addition, in the situation of FIG. 5, the second access point 3b is not used at all.

Next, a method of controlling wireless communications by the first access point 3a in the above situation is described.

As described above, the first access point 3a wirelessly communicates with the plurality of wireless communication terminals 7a, 7b and 7c. In such a situation where accesses from many wireless communication terminals concentrate on the first access point 3a, the communicating states of the wireless communication terminals 7a, 7b and 7c which are connected with the same first access point 3a are degraded. In the meantime, in the example of FIG. 5, the wireless communication terminal 7a among the plurality of wireless communication terminals within in the service area 5a is located in the furthest distance from the first access point 3a. Therefore, for the sake of description, it is assumed that the communicating state of the wireless communication terminal 7a is the worst among all the wireless communication terminals within the service area 5a.

Therefore, if the number of the wireless communication terminals connected with the first access point 3a increases and the entire communicating state is degraded, the number of retries of the wireless communication terminal 7a will exceed the threshold which is stored in the number-of-retries threshold storage 27 (that is, the communicating state of the wireless communication terminal 7a will be degraded worse than the predetermined condition) at a certain time point.

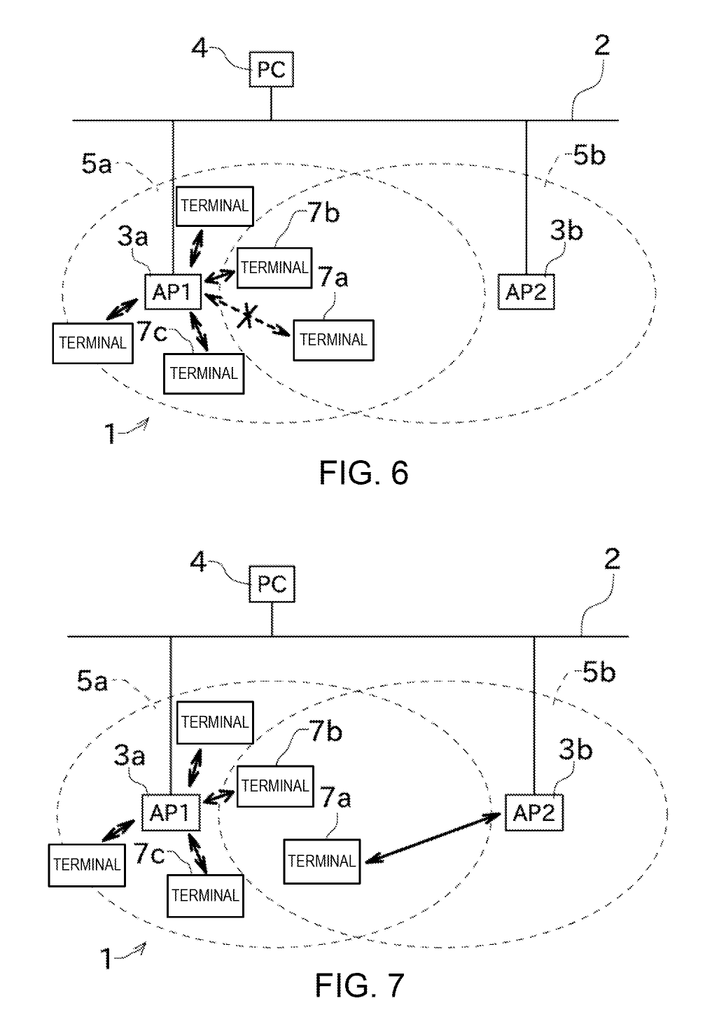

The communicating state managing unit 20 of the first access point 3a manages the information on the communicating state between the wireless communication unit 10 and each wireless communication terminal by using the communicating state table 23. The disconnecting unit 21 monitors the communicating state table 23, and it detects when the communicating state of the wireless communication terminal 7a gets worse than the predetermined condition. The disconnecting unit 21 cuts the communication (disconnect) between the wireless communication terminal 7a and the wireless communication unit 10, as illustrated in FIG. 6.

Thus, by disconnecting the wireless communication terminal 7a of which the communicating state got worse, the band which is usable by other wireless communication terminals 7b and 7c increases to improve the communicating states (in addition, the numbers of retries by the wireless communication terminals 7b and 7c decrease as a result).

On the other hand, the wireless communication terminal 7a which is disconnected from the first access point 3a again seeks access points in the situation of FIG. 6. In the meantime, in FIG. 6, the situation has been changed from FIG. 4, and the load is concentrated on the first access point. Therefore, when the wireless communication terminal 7a seeks access points in the situation of FIG. 6, other access points with better communicating states than the first access point 3a may be found. In such a case, the wireless communication terminal 7a selects one of other access points with a better sufficient communicating state (the second access point 3b) and starts communications as illustrated in FIG. 7. Thus, also at the wireless communication terminal 7a side which is disconnected from the first access point 3a, it may be able to switch the access point to one of other access points with better communicating states. Therefore, the communicating state of the wireless communication terminal 7a can also be achieved.

As described above, when communications are concentrated on the first access point 3a, the connection between the wireless communication terminal 7a and the first access point of which the communicating state got worse can be cut to urge the wireless communication terminal 7a to connect with one of other access points (in FIG. 7, the second access point 3b). On the other hand, since the access points 3a and 3b which constitute the wireless network 1 have the same configuration as described above, when the communications are concentrated on the second access point 3b, the connection between the wireless communication terminal and the second access point 3b of which the communicating state got worse can be cut to urge the wireless communication terminal to connect with one of other access points (e.g., the first access point 3a). Thus, it can prevent the accesses from concentrating on a particular access point.

In addition, the communicating state can be improved both for the wireless communication terminal 7a disconnected from the first access point 3a and other wireless communication terminals 7b and 7c still connecting with the first access point 3a. Therefore, according to the first access point 3a, the overall performance of the wireless network 1 can be improved.

Of course, when the wireless communication terminal 7a of FIG. 6 compares the first access point 3a with other access points (e.g., the second access point 3b), the communicating state of the first access point 3a may still be the best. Alternatively, for example, a wireless terminal such as the wireless terminal 7c of FIG. 6 which is located outside the service area 5b of the second access point 3b cannot select any access point other than the first access point 3a one way or the other. In such a case, this wireless communication terminal again selects the first access point 3a and reconnects with the first access point 3a.

As described above, the disconnecting unit 21 does not disconnect the wireless communication terminal of which the elapsed time after the last disconnection is less than the predetermined time. Therefore, when the disconnected wireless communication terminal tries to reconnect with the first access point 3a, the connection between the wireless communication terminal and the first access point 3a can be avoided from disconnecting again. As a result, the repeating of connecting and disconnecting between the wireless communication terminal and the access points 3a within a short period of time can be prevented.

In this case, the disconnecting unit 21 cannot disconnect the reconnected wireless communication terminal for a predetermined period of time. Therefore, during this predetermined period of time, if a communicating state with another wireless communication terminal which is different from the reconnected wireless communication terminal becomes worse than the predetermined condition, the disconnecting unit 21 disconnects this wireless communication terminal. Then, when this disconnected wireless communication terminal found a better access point than the first access point 3a, it starts communications with this better access point. Thus, by repeating the above-described processing, roaming of each wireless communication terminal to the access point of which the communicating state is the best for the wireless terminal can be achieved.

Note that, in this embodiment, the administrator of the wireless network 1 can set the predetermined condition to disconnect the wireless communication terminal 7 (particularly, the threshold values stored in the threshold storages 25, 26 and 27 of the disconnecting unit 21). If the radio wave intensity threshold or the communication rate threshold is set larger, or if the number-of-retries threshold is set smaller, the connection between the first access point 3a and the wireless communication terminal 7 becomes easier to be cut when the communicating state is degraded. On the contrary, if the radio wave intensity threshold or the communication rate threshold is set smaller, or if the number-of-retries threshold is set larger, the connection between the first access point 3a and the wireless communication terminal 7 becomes more difficult to be cut when the communicating state is degraded. Therefore, the administrator of the wireless network 1 can adjust the frequency of disconnecting the wireless communication terminal 7 (frequency of roaming) by suitably setting the thresholds. As a result, the roaming operation can be adjusted flexibly according to the practical configuration of the wireless network 1.

Next, another situation different from the above is described.

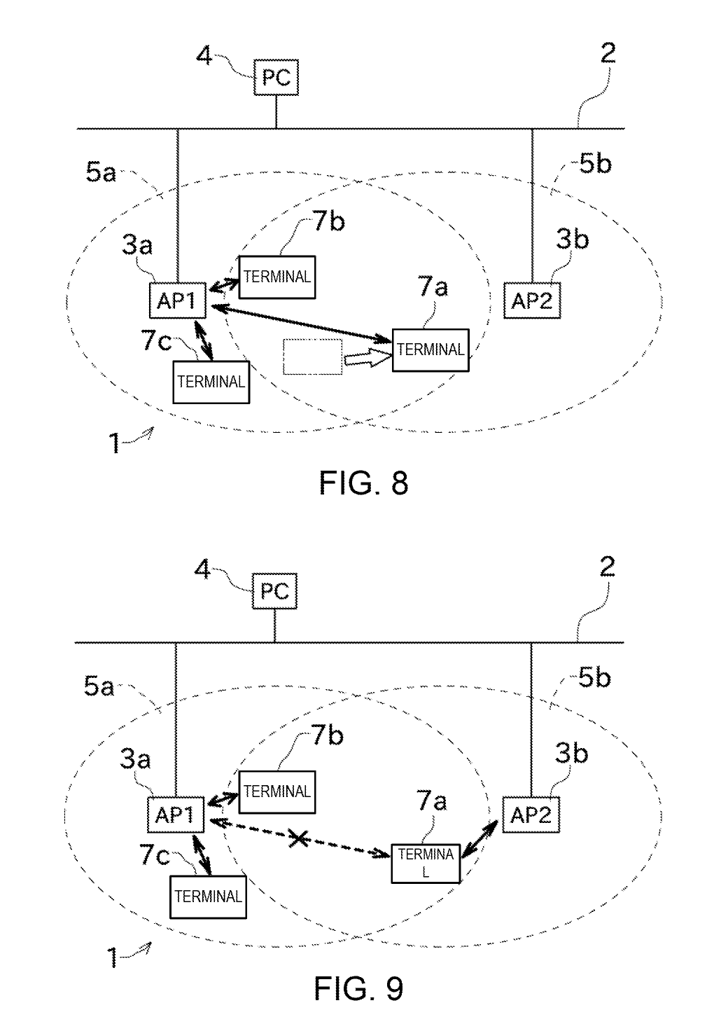

For example, it is assumed that the wireless communication terminal 7a of the state of FIG. 5 moved away from the first access point 3a and approached the second access point 3b, as illustrated in FIG. 8. As the wireless communication terminal 7a moves away from the first access point 3a, the radio wave intensity of the wireless communication terminal 7a is lowered (that is, the communicating state between the wireless communication terminal 7a and the first access point gets worse). On the other hand, since the wireless communication terminal 7a approaches the second access point 3b, the wireless communication terminal 7a and the second access point 3b can communicate with each other with sufficient radio wave intensity. However, since the wireless communication terminal 7a tends to maintain the connection with the first access point 3a, the wireless communication terminal 7a does not switch the access point to the second access point 3b unless the circumstance changes.

As a result of the communicating state having got worse as the wireless communication terminal 7a of FIG. 8 moved away from the first access point 3a, the communication between the wireless communication terminal 7a and the first access point 3a occupies the band so that bands of the communications between other wireless communication terminals 7b and 7c, and the first access point 3a are narrowed down. Thus, other wireless communication terminals 7b and 7c have to wait for communications to start. Therefore, when the wireless communication terminal 7a of which the communicating state is extremely bad exists among the wireless communication terminals connected with the first access point 3a, it may degrade the communicating states of other wireless communication terminals 7b and 7c as well. In addition, since communications of other wireless communication terminals 7b and 7c which have been waiting will rush immediately after the communication of the wireless communication terminal 7a is finished, another problem of increasing an error rate of the communications may be caused.

In this regard, according to the first access point 3a, for example, when the radio wave intensity of the wireless communication terminal 7a becomes less than the radio wave intensity threshold (i.e., when the communicating state of the wireless communication terminal 7a gets worse than the predetermined condition), the disconnecting unit 21 cuts the connection between the wireless communication terminal 7a and the first access point 3a (FIG. 9). By this, since the wireless communication terminal 7a of which the communicating state is extremely bad can be disconnected from the first access point 3a, the band occupancy by the wireless communication terminal 7a can be prevented and, thus, the communicating states of other wireless communication terminals 7b and 7c can be improved. In addition, since the other wireless communication terminals 7b and 7c do not have to wait for their communications, the communication-rushes by the wireless communication terminals can be prevent and, thus, the error rate can be reduced.

Note that, in the case of FIG. 9, since the wireless communication terminal 7a has moved to near the second access point 3b, it is possible to communicate with the second access point 3b in a good communicating state. Therefore, the wireless communication terminal 7a can select the second access point 3b of which a reception state is better to resume communications. Thus, according this embodiment, since the connection between the wireless communication terminal 7a and the first access point 3a of which the communicating state got worse is cut, the wireless communication terminal 7a is given an opportunity to switch to a better access point as a result. Therefore, the wireless communication terminal 7a of which the connection with the first access point 3a is cut is also given an advantage of improving the communicating state. In addition, the performance of the entire wireless network 1 can be improved.

Summarizing the above embodiment, the first access point 3a includes the wireless communication unit 10, the communicating state managing unit 20, and the disconnecting unit 21. The wireless communication unit 10 wirelessly communicates with each of the plurality of wireless communication terminals. The communicating state managing unit 20 manages the information on the communicating states between the wireless communication unit 10 and the respective wireless communication terminals. The disconnecting unit 21 cuts the connection between the wireless communication terminal and the wireless communication unit 10 of which the communicating state managed by the communicating state managing unit 20 gets worse than the predetermined condition.

Thus, the wireless communication terminal of which the communicating state is bad is detected and disconnected at the access point side, roaming can be urged so that the wireless communication terminal tries to connect with another access point of which the communicating state is better. Therefore, since accesses are distributed over the plurality of access points and each wireless communication terminal has a higher possibility to be able to connect with more advantageous access point, the performance of the entire wireless network can be improved.

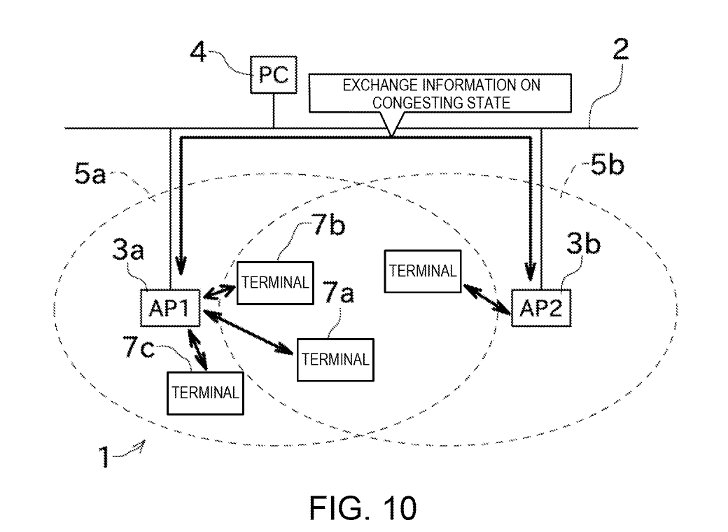

Next, a modification of the above embodiment is described with reference to FIG. 10.

In this modification, a plurality of access points which constitute wireless networks (in FIG. 10, a first access point 3a and a second access point 3b) mutually exchange information on a congesting state to dynamically change the predetermined condition for the disconnection of the wireless communication terminal 7 (particularly, the threshold values stored in the threshold storages 25, 26 and 27).

The “information on a congesting state” exchanged by the access points 3a and 3b may include information on the number of the wireless communication terminals 7 connected with each of the access points 3a and 3b. For example, in the example of FIG. 10, more wireless communication terminals are connected with the first access point 3a, compared with the second access point 3b. That is, the first access point 3a is more congested than the second access point. Note that the information related to the congesting state may be any other information including, but not limited to, information from which the congesting state of each of the access points 3a and 3b can be determined. For example, the total traffic per unit time of each of the access points 3a and 3b may be used as the information on the congesting state of each access point.

The controller 12 of each of the access points 3a and 3b transmits the information on the congesting state of the access point itself periodically or irregularly via the wired network 2 to the other access point. The controller 12 of each of the access points 3a and 3b then receives the information on the congesting state transmitted from the other access point via the wired network 2. Therefore, each of the access points 3a and 3b can mutually share the information on the congesting state.

The disconnecting unit 21 of each of the access points 3a and 3b changes the predetermined condition (particularly, the thresholds stored in the threshold storages 25, 26 and 27), when there is a difference in the congesting state between one access point and the other access point, so that the difference is neutralized.

For example, the disconnecting unit 21 of the first access point 3a compares its congesting state with the congesting state of the other access point (in FIG. 9, the second access point 3b), and loosen up the predetermined condition for disconnecting the wireless communication terminal more as the congestion of the first access point 3a increases (that is, the wireless communication terminal is made easier to be disconnected). Specifically, when the disconnecting unit 21 of the first access point 3a determines that the first access point 3a is relatively congested, the disconnecting unit 21 increases the radio wave intensity threshold or the modulation rate threshold stored in the threshold storages 25 and 26 of the first access point 3a, or decreases the number-of-retries threshold stored in the threshold storage 27 of the first access point 3a. As a result, when the first access point 3a is congested, the connection between the access point 3a and the wireless communication terminals becomes easier to be cut and, thus, the congestion becomes easier to be resolved.

In addition, the disconnecting unit 21 of the first access point 3a tightens up the predetermined condition for disconnecting the wireless communication terminal more as the congestion of the other access point (the second access point 3b) increases (in other words, the congestion of the first access point 3a is less). That is, the wireless communication terminal is made harder to be disconnected). Specifically, the disconnecting unit 21 of the first access point 3a decreases the radio wave intensity threshold or the modulation rate threshold stored in the threshold storages 25 and 26 of the first access point 3a, or increases the number-of-retries threshold stored in the threshold storage 27 of the first access point 3a, when the disconnecting unit 21 determines that the first access point 3a is not relatively congested. Accordingly, when the first access point 3a is not congested, the connection between the access point 3a and the wireless communication terminal becomes harder to be cut and, thus, the first access point 3a becomes easier to accept the wireless communication terminal which is switched from the other access point.

In this modification, the disconnecting unit 21 of the first access point 3a may change all the radio wave intensity threshold, the modulation rate threshold, and the number-of-retries threshold based on the relative congesting state of the first access point 3a, or may selectively change only any one or two of the thresholds. In addition, it may be suitable if the administrator of the wireless network 1 can set how much each threshold is changed according to the relative congesting state of the access point concerned.

According to the above configuration, at the access point which is relatively congested, the wireless communication terminal of which the communicating state is bad is made easier to be disconnected, and, on the other hand, at the access point which is not relatively congested, the wireless communication terminal is made harder to be disconnected. Therefore, since the wireless communication terminal 7 becomes easier to change the access point from one access point which is relatively congested to another access point which is relatively not congested, the difference in congesting state between the access points 3a and 3b can be neutralized, and the access point of the wireless communication terminal 7 can be distributed over the access points 3a and 3b, as a result.

Although the suitable embodiment and suitable modifications of the present invention are described above, the above configurations may also be modified as follows.

For example, the information related to the communicating state detected by the communicating state detector 14 (the radio wave intensity, the modulation rate, and the number of retries) may contain errors, and the information values may differ in each communication. For this reason, if the communication between the wireless communication terminal the wireless communication unit 10 is performed twice or more to acquire a plurality of information on the communicating state, and the communicating state of the wireless communication terminal is determined based on the plurality of information, more exact determination is possible. For example, the communicating state managing unit 20 calculates an appropriate value in a statistical way, such as calculating averages of the radio wave intensities, the modulation rates, and the numbers of retries which can be obtained from the multiple communications, or calculating averages after removing the maximum value and the minimum value, respectively, and stores the calculated averages in the communicating state table 23. Accordingly, since the disconnecting unit 21 compares the calculated value obtained for the multiple communications with the threshold, a more appropriate determination can be performed. Of course, the communicating state managing unit 20 may record the plurality of information acquired from the multiple communications in the communicating state table 23 as they are. In such a case, the disconnecting unit 21 calculates an appropriate value by taking an average of the plurality of information recorded in the communicating state table 23, and then compares the stored value with the threshold. Note that it may be configured so that the administrator of the wireless network 1 is able to set whether or not the information acquired from the multiple communications is taken into the consideration.

In the above embodiment, although the radio wave intensity, the modulation rate, and the number of retries are illustrated as examples of the information on the communicating state, this information may be any other information from which the wireless communicating state between the wireless communication terminal and the access point can be determined. For example, the communicating state of each wireless communication terminal may be determined using the value of the number of errors 34 recorded in the communicating state table 23 (it can be concluded that the communicating state gets worse as the number of errors increases). Alternatively, for example, the error rate of each wireless communication terminal (a ratio of the number of errors with respect to the number of communication tries) may be recorded in the communicating state table 23, and the communicating state of each wireless communication terminal may be determined using the stored error rate (it can be concluded that the communicating state gets worse as the error rate increases).

Although, in the above embodiment, the wireless communication terminal of which the communicating state got worse is detected using all of the information on the radio wave intensity, the modulation rate, and the number of retries, only any one or two of the information may be used. Further, in the above embodiment, when any one of the conditions, such as the radio wave intensity is less than the threshold, the modulation rate is less than the threshold, or the number of retries exceeds the threshold, is satisfied, the wireless communication terminal is disconnected. However, the disconnection may also be performed only when all the conditions are satisfied. Further, the “predetermined condition” for the detection of the wireless communication terminal of which the communicating state got worse in the disconnecting unit 21 is not limited to the comparison of the thresholds, as long as the wireless communication terminal of the communicating state got worse than the predetermined state can be detected based on a comprehensive consideration of the information on the communicating state of each wireless communication terminal recorded in the communicating state table 23.

In the above embodiment, although the communicating state table 23 refers to the communicating state table 23 at the certain interval, the disconnecting unit 21 may do the same irregularly.

In the above embodiment, when the disconnected wireless communication terminal 7 is reconnected, the disconnecting unit 21 does not again disconnect the same wireless communication terminal 7 for the predetermined period of time. Instead, when the disconnected wireless communication terminal 7 tries a reconnection with the wireless communication unit 10, the reconnection may not be permitted for the predetermined period of time. In this case, it is suitable if the administrator of the wireless network 1 can set the time period for which the reconnection is not permitted. Accordingly, by not permitting the reconnection of the disconnected wireless communication terminal 7 for the predetermined period of time, the wireless communication terminal 7 can be urged to connect with another access point. Therefore, flexibility can be given to the wireless network 1 by enabling the setting of the time period for which the reconnection is not permitted.

Although, in the above modification, the thresholds are changed dynamically, it can be set by the administrator of the wireless network 1 whether or not the change is performed. Although, in the above modification, the information on the congesting state is shared between the access points, a server which unitary collects the information on the congesting state of each access point may determine a relative congesting state of each access point.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

What is claimed is:

1. An access point of wireless communications, comprising:
a wireless communication unit for wirelessly communicating with a plurality of wireless communication terminals;
a communicating state managing unit for managing information on a communicating state between the wireless communication unit and each of the wireless communication terminal; and
a disconnecting unit for cutting a connection between the wireless communication unit and the wireless communication terminal of which the communicating state managed by the communicating state managing unit gets worse than a predetermined condition.

2. The access point of claim 1, wherein the communicating state managing unit updates the information on the communicating state periodically or irregularly for each of the wireless communication terminals.

3. The access point of claim 2, wherein the communicating state managing unit transmits a predetermined signal to the wireless communication terminal that has not communicated with the access point for a predetermined period of time, and updates the information on the communicating state based on a communicating state of a response signal for the predetermined signal from the wireless communication terminal.

4. The access point of claim 1, wherein the information on the communicating state is an intensity of a radio wave received from the wireless communication terminal by the wireless communication unit.

5. The access point of claim 1, wherein the information on the communicating state is a modulation rate of a communication packet exchanged between the wireless communication unit and the wireless communication terminal.

6. The access point of claim 1, wherein the information on the communicating state is the number of retries of the communication between the wireless communication unit and the wireless communication terminal.

7. The access point of claim 1, wherein the information on the communicating state is an error rate of the communication between the wireless communication unit and the wireless communication terminal.

8. The access point of claim 1, wherein the disconnecting unit cuts the connection between the wireless communication unit and the wireless communication terminal of which the communicating state gets worse than the predetermined condition based on the information on the communicating state acquired from multiple communications between the wireless communication unit and the wireless communication terminal.

9. The access point of claim 1, wherein, when the wireless communication terminal that is disconnected reconnects with the wireless communication unit, the disconnecting unit does not cut the connection between the wireless communication terminal and the wireless communication unit for a predetermined period of time.

10. The access point of claim 1, wherein the disconnecting unit adjusts the predetermined condition based on information on congesting states of one or more other access points.

11. The access point of claim 10, wherein the information on the congesting state of the access point includes at least one of the number of the wireless communication terminals that are connecting with the access point and traffic of the access point per unit time.

12. The access point of claim 10, wherein the access point transmits the information on the congesting state of the access point to another access point, while the access point receives the information on the congesting state of the another access point, and
wherein the access point detects a relative congesting state of the access point based on the information on the congesting state of the access point and the received congesting state of the another access point, and adjusts the predetermined condition according to the relative congesting state.

13. The access point of claim 10, wherein the disconnecting unit loosens up the predetermined condition as the access point becomes relatively congested compared with another access point.

14. A method of controlling wireless communications, comprising:
wirelessly communicating between an access point and a plurality of wireless communication terminals;
managing, by the access point, information on a communicating state between the access point and the wireless communication terminal for each wireless communication terminal; and
cutting, by the access point, a connection between the access point and the wireless communication terminal of which the communicating state gets worse than a predetermined condition.
